(19) United States
(12) Patent Application Publication
(10) Pub. No.: US 2026/0075420 A1
(43) Pub. Date: Mar. 12, 2026

(54) SYSTEMS AND METHODS FOR BARRING AND UNBARRING NETWORK SLICES

(71) Applicant: Verizon Patent and Licensing Inc., Basking Ridge, NJ (US)

(72) Inventors: Riyaj Uddin AHMED, Coppell, TX (US); Parry Cornell BOOKER, Sunnyvale, TX (US)

(73) Assignee: Verizon Patent and Licensing Inc., Basking Ridge, NJ (US)

(21) Appl. No.: 18/830,835

(22) Filed: Sep. 11, 2024

(51) Int. Cl. H04W 12/082

(52) U.S. Cl. CPC H04W 12/082

(57) ABSTRACT

A first network device may receive a first command to bar a network slice associated with a subscriber, and may identify, based on the first command, the subscriber, the network slice to be barred, and one or more active sessions associated with the network slice and the subscriber. The first network device may provide, to a second network device, a notification indicating to terminate the one or more active sessions associated with the network slice and the subscriber and to bar the network slice for the subscriber.

### BACKGROUND

In managing network resources, network operators rely on network slicing technology to allocate and maintain different services for users.

### BRIEF DESCRIPTION OF THE DRAWINGS

FIGS. 1A-1C are diagrams of an example associated with barring and unbarring network slices.

FIG. 2 is a diagram of an example environment in which systems and/or methods described herein may be implemented.

FIG. 3 is a diagram of example components of one or more devices of FIG. 2.

FIG. 4 is a flowchart of an example process for barring and unbarring network slices.

### DETAILED DESCRIPTION OF EXAMPLE EMBODIMENTS

The following detailed description of example implementations refers to the accompanying drawings. The same reference numbers in different drawings may identify the same or similar elements.

Network slicing allows for the segregation of network architecture to support diverse requirements from different types of traffic, applications, or users. Typical network management activities may require barring or unbarring access to network slices to control a quality of service (QoS), manage resources, or perform maintenance activities. However, current techniques for barring access to a network slice require removal of the network slice, and reprovisioning of the network slice when access to the network slice is unbarred. Furthermore, current techniques require barring multiple subscribers to a network slice one at a time. Thus, current techniques for handling network slices consume computing resources (e.g., processing resources, memory resources, communication resources, and/or the like), networking resources, and/or other resources associated with removing barred network slices and reprovisioning the network slices when they are unbarred, barring multiple subscribers to a network slice one at a time, failing to provide quick and efficient access to subscribers when the subscribers are unbarred from a network slice, and/or the like.

Some implementations described herein provide a network device (e.g., a unified data repository (UDR) and/or a unified data management (UDM) device) that efficiently manages network slicing by enabling swift barring and unbarring of network slices at both a subscriber level and a global level. For example, a network device may receive a command to bar a network slice associated with a subscriber (or a group of subscribers), and may identify, based on the command, the subscriber (or the group of subscribers), the network slice to be barred, and one or more active sessions associated with the network slice and the subscriber (or the group of subscribers). The network device may provide, to another network device, a notification indicating to terminate the one or more active sessions associated with the network slice and the subscriber (or the group of subscribers) and to bar the network slice for the subscriber (or the group of subscribers). The other network device may interact with one or more other network devices to terminate the one or more active sessions associated with the network slice and the subscriber (or the group of subscribers) and to bar the network slice for the subscriber (or the group of subscribers). The network device may store provisioning data for the network slice so that the network device may quickly unbar the network slice for the subscriber (or the group of subscribers) at a later time.

In this way, the network device bars and unbars network slices. For example, the network device may provide automated and centralized management capabilities to streamline network operations, and may mitigate a need for cumbersome manual configurations associated with barring or unbarring network slices. This may provide more efficient use of network device processing capabilities by reducing a quantity of manual commands needed to bar or unbar subscribers. The network device may minimize a quantity of active sessions that need to be synchronized when barring actions are executed, and may increase an agility of a network to adapt to fluctuating service demands and network conditions. Thus, the network device may conserve computing resources, networking resources, and/or other resources that would have otherwise been consumed by removing barred network slices and reprovisioning the network slices when they are unbarred, barring multiple subscribers to a network slice one at a time, failing to provide quick and efficient access to subscribers when the subscribers are unbarred from a network slice, and/or the like.

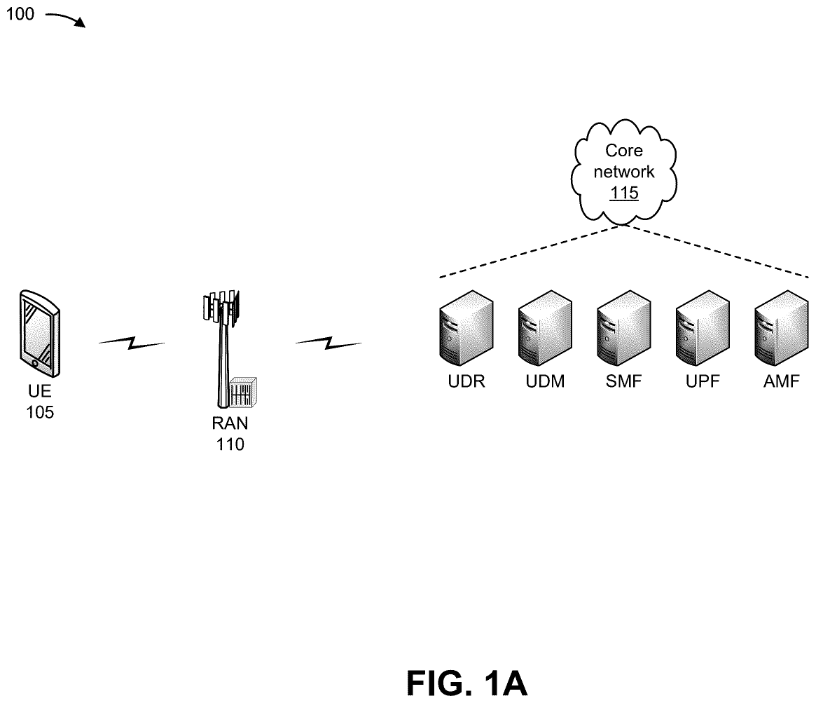

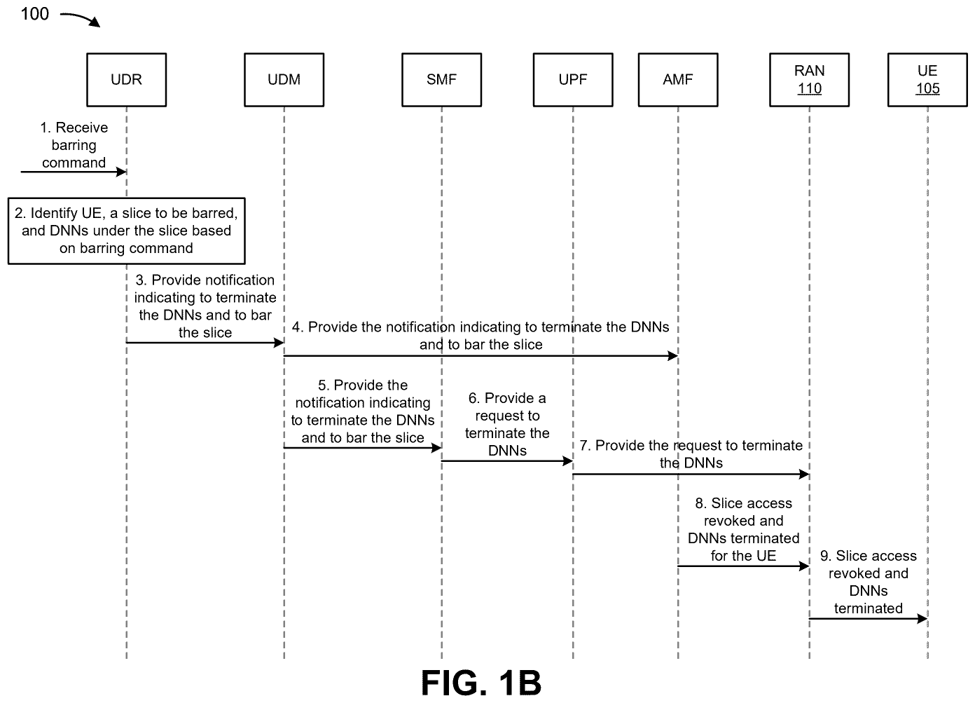

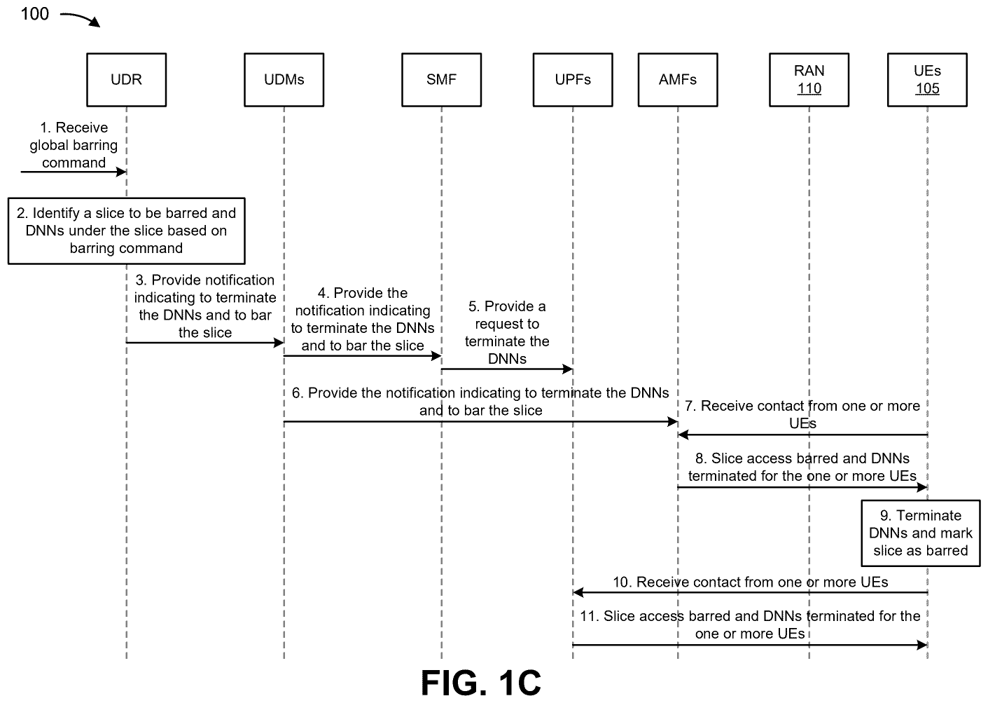

FIGS. 1A-1C are diagrams of an example 100 associated with barring and unbarring network slices. As shown in FIGS. 1A-1C, the example 100 includes a user equipment (UE) 105, a radio access network (RAN) 110, and a core network 115 that includes a unified data repository (UDR), a unified data management (UDM) device, a session management function (SMF), a user plane function (UPF), and an access and mobility management function (AMF). Further details of the UE 105, the RAN 110, the core network 115, the UDR, the UDM, the SMF, the UPF, and the AMF are provided elsewhere herein.

FIG. 1B depicts an example information flow associated with barring a network slice for a particular subscriber (e.g., the UE 105). For example, a user of the UE 105 may wish to temporarily utilize a network slice for a network service (e.g., a vehicle-to-everything (V2X) service). The UE 105 may request and receive the network service, via the network slice, and may eventually request termination of the network service. Instead of deleting the network slice for the network service, the core network 115 may bar the network slice for the UE 105. If the UE 105 wishes to utilize the network slice again, the core network 115 may simply unbar the network slice for the UE 105. In that way, the core network 115 may avoid deleting the network slice subscription from the UE 105.

As shown at step 1 of FIG. 1B, a barring command may be received by the UDR of the core network 115. For example, the UDR may receive the barring command from a network operator or an automated system, commanding the UDR to bar a network slice associated with a subscriber (e.g., the UE 105). In some implementations, the UDR may receive the barring command via a network management interface or from an operations support system (OSS) platform or a business support system (BSS) platform. For example, the barring command may be transmitted through a web-based management console interfacing with the UDR.

As shown at step 2, based on the barring command, the UDR may identify the UE 105, a network slice to be barred, and data network names (DNNs) associated with the network slice and the UE 105. For example, based on the barring command, the UDR may analyze a subscriber database to identify the subscriber, the UE 105 associated with the subscriber, the network slice to be barred, and the DNNs associated with the network slice and the UE 105 (e.g., and to be terminated). In some implementations, the UDR may also identify any associated quality of service (QoS) policies and bearer contexts associated with the UE 105. For example, the UDR may retrieve QoS parameters and bearer setup details associated with the UE 105 to ensure complete barring of the network slice for the UE 105.

As shown at step 3, the UDR may provide, to the UDM, a notification indicating to terminate the DNNs associated with the network slice and the UE 105 and to bar the network slice for the UE 105. For example, the UDR may generate the notification indicating to terminate the DNNs associated with the network slice and the UE 105 and to bar the network slice for the UE 105. The UDR may provide the notification to the UDM, and the UDM may receive the notification. The notification may prompt the UDM to begin taking actions toward terminating connections associated with the network slice and the UE 105. In some implementations, the UDR may provide the notification to a policy control function (PCF) of the core network 115, instead of or in addition to the UDM, to inform the PCF about the termination of the connections and the barring of the network slice for the UE 105. For example, the PCF may handle policy-related decisions and therefore may be integral in enforcing the barring command.

As shown at step 4, the UDM may provide, to the AMF, the notification indicating to terminate the DNNs associated with the network slice and the UE 105 and to bar the network slice for the UE 105. For example, the UDM may provide the notification to the AMF to inform the AMF about the termination of the DNNs associated with the network slice and the UE 105 and the barring of the network slice for the UE 105. In some implementations, the UDM may provide, to the AMF, specific parameters (e.g., QoS settings) in addition to the notification indicating to terminate the DNNs associated with the network slice and the UE 105 and to bar the network slice for the UE 105. For example, the QoS settings may dictate a priority level and permissible transmission rates during the DNN termination process.

As shown at step 5, the UDM may provide, to the SMF, the notification indicating to terminate the DNNs associated with the network slice and the UE 105 and to bar the network slice for the UE 105. For example, the UDM may provide the notification to the SMF to inform the SMF about the termination of the DNNs associated with the network slice and the UE 105 and the barring of the network slice for the UE 105. In some implementations, the UDM may provide the notification to the SMF as well as to multiple AMFs to ensure redundancy and faster response times in large networks. For example, providing the notification to multiple AMFs may balance network load and enhance reliability.

As shown at step 6, the SMF may provide, to the UPF, a request to terminate the DNNs associated with the network slice and the UE 105. For example, based on the notification, the SMF may generate the request to terminate the DNNs associated with the network slice and the UE 105, and may provide the request to the UPF. The request may instruct the UPF to cease data transmission for the DNNs associated with the network slice and the UE 105. In some implementations, the SMF may be enhanced to handle complex session management tasks. For example, the SMF may be enhanced to manage multiple sessions efficiently by optimizing network resource allocation.

As shown at step 7, the UPF may provide, to the RAN 110, the request to terminate the DNNs associated with the network slice and the UE 105. For example, the UPF may forward the request to terminate the DNNs associated with the network slice and the UE 105 to the RAN 110. The RAN 110 may receive the request to terminate and may terminate the DNNs for the UE 105 based on the request. This may ensure that the RAN 110 stops delivering data along the terminated DNNs. In some implementations, the UPF may provide the request to terminate the DNNs to an edge data network (EDN). The EDN may terminate the DNNs for the UE 105 to ensure lower latency for the UE 105. For example, the EDN may be physically located closer to the UE 105 in the network architecture, enabling quicker termination of DNNs for the UE 105.

As shown at step 8, the AMF may provide, to the RAN 110, a message indicating that access to the network slice has been revoked for the UE 105 and that the DNNs associated with the network slice and the UE 105 have been terminated. For example, the AMF may generate the message indicating that access to the network slice has been revoked for the UE 105 and that the DNNs associated with the network slice and the UE 105 have been terminated. The AMF may provide the message to the RAN 110 to inform the RAN 110 about the removal of the network slice and the termination of the DNNs of the UE 105. In some implementations, the message may include additional metadata, such as a timestamp and a reason for revocation of the network slice, which may enhance an ability of the RAN 110 to log and troubleshoot. For example, such information may be useful for network diagnostics in case of service issues.

As shown at step 9, the RAN 110 may provide, to the UE 105, the message indicating that access to the network slice has been revoked for the UE 105 and that the DNNs associated with the network slice and the UE 105 have been terminated. For example, the RAN 110 may forward the message to the UE 105 so that the UE 105 is aware that access to the network slice has been revoked for the UE 105 and that the DNNs associated with the network slice and the UE 105 have been terminated. The UE 105 may thus be aware that the UE 105 cannot use the network slice until the network slice is unbarred by the UDR. In some implementations, the message may include an end-user message explaining the barring reasons and next steps for re-enabling the network slice. For example, this might help the user understand why access to the network slice was revoked and what actions, if any, the user can take to regain access to the network slice.

In some implementations, the UDR may store network slice provisioning data utilized to instantiate the network slice for the UE 105 so that the network slice may be quickly reinstated for the UE 105 at a later time. When the user of the UE 105 wishes to utilize the network slice again, the UDR may receive an unbarring command. Based on the unbarring command, the UDR may unbar the network slice for the UE 105. The UDR may utilize the stored network slice provisioning data to quickly reinstate the network slice and the terminated DNNs for the UE 105.

FIG. 1C depicts an example information flow associated with globally barring a network slice for all subscribers (e.g., all UEs 105). For example, if a network slice needs to be provided maintenance for a time period, the core network 115 may globally bar the network slice for all subscribers (e.g., all UEs 105) utilizing the network slice. This is much more efficient than current techniques that would delete the network slice and remove the network slice from all subscribers one by one.

As shown at step 1 of FIG. 1B, a global barring command may be received by the UDR of the core network 115. For example, the UDR may receive the global barring command from a network operator or an automated system, instructing the UDR to bar a network slice for all UEs 105 associated with the core network 115. In some implementations, the global barring command may be received by the UDR from an orchestration system or network management system instead of a network operator. For example, an orchestration system can automate command execution based on pre-defined policies. Additionally, or alternatively, the UDR may receive the global barring command via a network management interface or from an OSS platform or a BSS platform.

As shown at step 2, based on the global barring command, the UDR may identify a network slice to be globally barred, UDMs associated with the network slice, and DNNs associated with the network slice. For example, based on the global barring command, the UDR may identify, from a subscriber database, the network slice to be globally barred, subscribers associated with the network slice, UEs 105 associated with the subscribers, UDMs associated with the network slice, and DNNs associated with the network slice. In some implementations, the UDR may utilize a machine learning model to analyze the subscriber database and identify the network slice to be globally barred, and the associated UEs 105, DNNs, and UDMs. For example, the machine learning model may enhance an accuracy and a speed of identifying the network slice to be globally barred, and the associated UEs 105, DNNs, and UDMs, by learning from past data patterns.

As shown at step 3, the UDR may provide, to the UDMs, a notification indicating to terminate the DNNs associated with the network slice and UEs 105 and to bar the network slice for the UEs 105. For example, the UDR may generate the notification indicating to terminate the DNNs associated with the network slice and the UEs 105 and to bar the network slice for the UEs 105. The UDR may provide the notification to the UDMs identified by the UDR. In some implementations, the UDR may include details related to traffic patterns or congestion levels in the notification to ensure that the termination of the affected DNNs is optimal. For example, including traffic patterns may prevent data loss and congestion during the termination process. Additionally, or alternatively, the notification may include additional parameters, such as QoS settings, to ensure complete termination and barring.

As shown at step 4, the UDMs may provide, to the SMF, the notification indicating to terminate the DNNs associated with the network slice and the UEs 105 and to bar the network slice for the UEs 105. For example, one or more of the UDMs may provide the notification to the SMF to inform the SMF about the termination of the DNNs associated with the network slice and the UEs 105 and the barring of the network slice for the UEs 105. In some implementations, the UDMs may initiate a logging event for record-keeping and auditing purposes. For example, the logging may ensure that network administrators can review the steps taken during the barring of the network slice. Additionally, or alternatively, the SMF may receive the notification and may begin the process of terminating the DNNs and globally barring the network slice for the UEs 105.

As shown at step 5, the SMF may provide, to the UPF, a request to terminate the DNNs associated with the network slice and the UEs 105. For example, based on the notification, the SMF may generate the request to terminate the DNNs associated with the network slice and the UEs 105. The SMF may provide the request to terminate the DNNs to the UPF. In some implementations, the request to terminate the DNNs may include specific instructions for various QoS levels for different types of data flows within the DNNs. For example, specifying QoS levels may ensure that high-priority traffic is appropriately handled during termination. Additionally, or alternatively, the request to terminate the DNNs may cause the UPF to cease data transmission for the affected DNNs.

As shown at step 6, the UDMs may provide, to the AMFs, the notification indicating to terminate the DNNs associated with the network slice and the UEs 105 and to bar the network slice for the UEs 105. For example, the UDMs may provide the notification to the AMFs to inform the AMFs about the termination of the DNNs associated with the network slice and the UEs 105 and the barring of the network slice for the UEs 105. In some aspects, the UDMs may send a broadcast notification to the AMFs to ensure that all relevant devices are updated simultaneously. For example, broadcasting the notification may reduce a risk of any AMF being left in an inconsistent state. Additionally, or alternatively, the AMFs may update configurations based on the notification to ensure that the network slice remains barred.

As shown at step 7, the AMFs may receive communications from one or more UEs 105 associated with the network slice. For example, one or more of the UEs 105 associated with the network slice may communicate with one or more of the AMFs. In some implementations, if the AMFs detect specific types of communications from the UEs 105 (e.g., emergency services requests), the AMFs may apply exceptions or different handling rules. For example, emergency calls from UEs 105 may be given priority access even if the network slice is barred. Additionally, or alternatively, any UE 105 attempting to access the barred network slice may be detected by one or more of the AMFs.

As shown at step 8, the AMFs may provide, to the UEs 105, a message indicating that access to the network slice has been revoked for the UEs 105 and that the DNNs associated with the network slice and the UEs 105 have been terminated. For example, based on the communications from the one or more UEs 105, the AMFs may generate the message indicating that access to the network slice has been revoked for the UEs 105 and that the DNNs associated with the network slice and the UEs 105 have been terminated. The AMFs may provide the message to the UEs 105 associated with the network slice. In some implementations, the AMFs may also provide, to a network operator, logs summarizing a status of the network slice and any relevant statistical information. For example, such logs may be utilized for performance assessment and future planning.

As shown at step 9, the UEs 105 may terminate the DNNs associated with the network slice and may mark the network slice as barred. For example, based on receiving the message, the UEs 105 may terminate the DNNs associated with the network slice and may mark the network slice as barred. In some implementations, while terminating the DNNs, the UEs 105 may implement processes to archive any unsent data packets associated with the barred network slice. For example, archiving the data may ensure that no critical information is lost when the network slice is barred.

As shown at step 10, the UPFs may receive contact from the UEs 105 associated with the network slice. For example, one or more of the UEs 105 associated with the network slice may communicate with one or more of the UPFs. In some implementations, the UPFs, in addition to processing communications from the UEs 105, may also direct the UEs 105 to alternative network slices or handle fallback configurations. For example, directing the UEs 105 to alternative network slices may ensure that the UEs 105 maintain connectivity despite the barring of the network slice.

As shown at step 11, the UPFs may provide, to the UEs 105, a message indicating that access to the network slice has been revoked for the UEs 105 and that the DNNs associated with the network slice and the UEs 105 have been terminated. For example, based on the communications from the one or more UEs 105, the UPFs may generate the message indicating that access to the network slice has been revoked for the UEs 105 and that the DNNs associated with the network slice and the UEs 105 have been terminated. The UPFs may provide the message to the UEs 105 associated with the network slice. In some implementations, the UPFs may send periodic status updates or retry messages to ensure that the UEs 105 are fully aware of the barred status of the network slice. For example, periodic updates may keep all UEs 105 associated with the network slice informed and prevent any miscommunication. The UEs 105 may not utilize the network slice again until the UDR unbars the network slice for the UEs 105 (e.g., after completion of the maintenance on the network slice).

In some implementations, the UDR may store network slice provisioning data utilized to instantiate the network slice for the UEs 105 so that the network slice may be quickly reinstated for the UEs 105 at a later time. When the network slice is to be reinstated, the UDR may receive an unbarring command. Based on the unbarring command, the UDR may unbar the network slice for the UEs 105. The UDR may utilize the stored network slice provisioning data to quickly reinstate the network slice and the terminated DNNs for the UEs 105.

In this way, the network device bars and unbars network slices. For example, the network device may provide automated and centralized management capabilities to streamline network operations, and may mitigate a need for cumbersome manual configurations associated with barring or unbarring network slices. This may provide more efficient use of network device processing capabilities by reducing a quantity of manual commands needed to bar or unbar subscribers. The network device may minimize a quantity of active sessions that need to be synchronized when barring actions are executed, and may increase an agility of a network to adapt to fluctuating service demands and network conditions. Thus, the network device may conserve computing resources, networking resources, and/or other resources that would have otherwise been consumed by removing barred network slices and reprovisioning the network slices when they are unbarred, barring multiple subscribers to a network slice one at a time, failing to provide quick and efficient access to subscribers when the subscribers are unbarred from a network slice, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

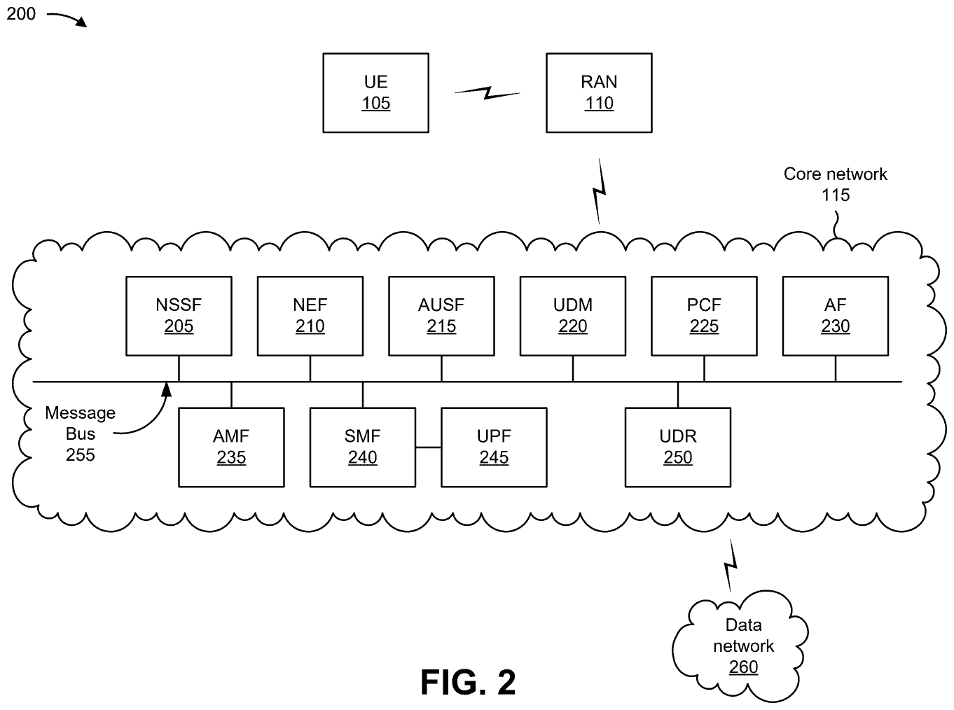

FIG. 2 is a diagram of an example environment 200 in which systems and/or methods described herein may be implemented. As shown in FIG. 2, the example environment 200 may include the UE 105, the RAN 110, the core network 115, and a data network 260. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or the core network 115. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

In some implementations, the core network 115 may include an example functional architecture in which systems and/or methods described herein may be implemented. For example, the core network 115 may include an example architecture of a 5G Next Generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a UDM 220, a policy control function (PCF) 225, an application function (AF) 230, an AMF 235, an SMF 240, a UPF 245, and/or a UDR 250. These functional elements may be communicatively connected via a message bus 255. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The UDR 250 includes one or more devices that store and manage data relevant to subscribers and network functions, such as user subscription information, policy data, and session context. The UDR 250 acts as a unified and centralized database that various network functions can access. The UDM 220 may retrieve subscription data from the UDR 250 during user authentication, mobility, and access management procedures. The PCF 225 may refer to the UDR 250 to get policy rules when enforcing policies for data sessions. The SMF 240 may access the UDR 250 for session-related data to manage and maintain user sessions effectively.

The message bus 255 represents a communication structure for communication among the functional elements. In other words, the message bus 255 may permit communication between two or more functional elements.

The data network 260 includes one or more wired and/or wireless data networks. For example, the data network 260 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third-party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

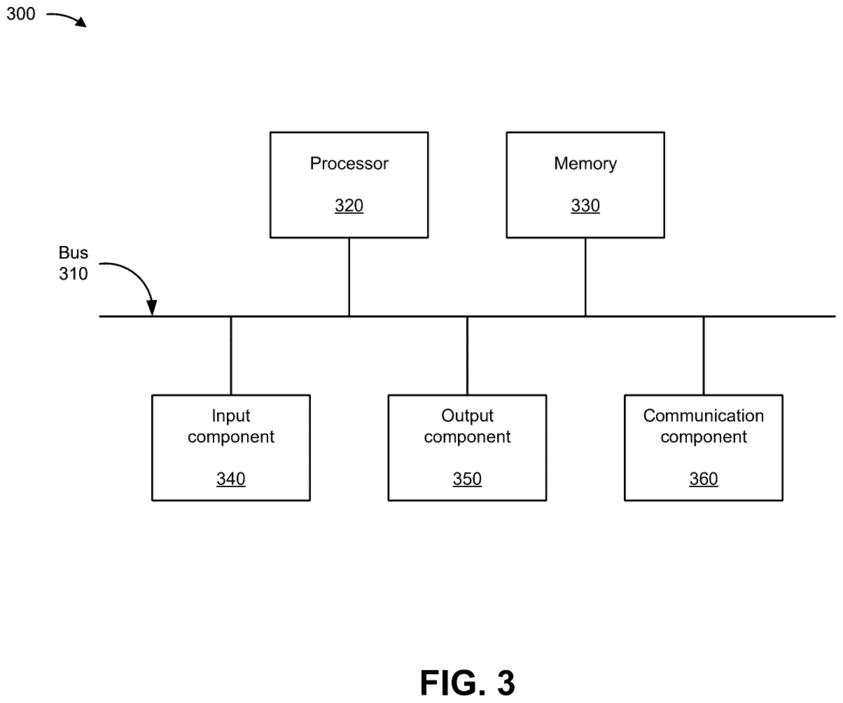

FIG. 3 is a diagram of example components of a device 300, which may correspond to the UE 105, the RAN 110, the NSSF 205, the NEF 210, the AUSF 215, the UDM 220, the PCF 225, the AF 230, the AMF 235, the SMF 240, the UPF 245, and/or the UDR 250. In some implementations, the UE 105, the RAN 110, the NSSF 205, the NEF 210, the AUSF 215, the UDM 220, the PCF 225, the AF 230, the AMF 235, the SMF 240, the UPF 245, and/or the UDR 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

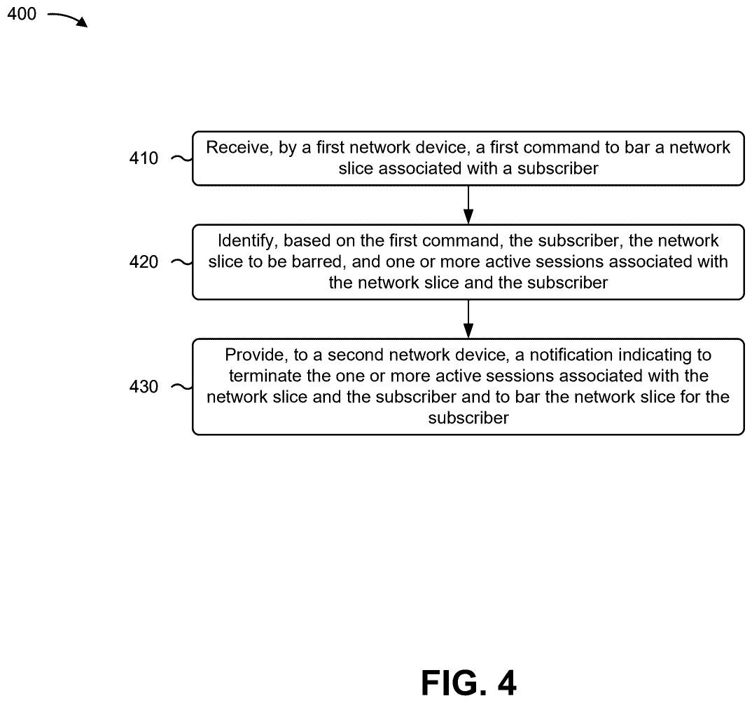

FIG. 4 is a flowchart of an example process 400 for barring and unbarring network slices. In some implementations, one or more process blocks of FIG. 4 may be performed by a first network device (e.g., the UDR 250). In some implementations, one or more process blocks of FIG. 4 may be performed by another device or a group of devices separate from or including the first network device, such as a UE (e.g., the UE 105), a UDM (e.g., the UDM 220), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a first command to bar a network slice associated with a subscriber (block 410). For example, the first network device may receive a first command to bar a network slice associated with a subscriber, as described above. In some implementations, the first command to bar the network slice is received from a network operator or an automated system. In some implementations, the subscriber is associated with a UE.

As further shown in FIG. 4, process 400 may include identifying, based on the first command, the subscriber, the network slice to be barred, and one or more active sessions associated with the network slice and the subscriber (block 420). For example, the first network device may identify, based on the first command, the subscriber, the network slice to be barred, and one or more active sessions associated with the network slice and the subscriber, as described above.

As further shown in FIG. 4, process 400 may include providing, to a second network device, a notification indicating to terminate the one or more active sessions associated with the network slice and the subscriber and to bar the network slice for the subscriber (block 430). For example, the first network device may provide, to a second network device, a notification indicating to terminate the one or more active sessions associated with the network slice and the subscriber and to bar the network slice for the subscriber, as described above. In some implementations, the notification causes the second network device to terminate the one or more active sessions associated with the network slice and the subscriber and to bar the network slice for the subscriber. In some implementations, the first network device is a UDR of a core network and the second network device is a UDM component of the core network. In some implementations, the notification causes the second network device to interact with one or more other network devices to terminate the one or more active sessions associated with the network slice and the subscriber and to bar the network slice for the subscriber.

In some implementations, process 400 includes receiving, after providing the notification, a second command to unbar the network slice associated with the subscriber, and causing the network slice associated with the subscriber to be unbarred based on the second command. In some implementations, the second command enables the subscriber to initiate an active session with the network slice. In some implementations, process 400 includes storing slice provisioning data associated with the network slice prior to providing the notification to the second network device.

In some implementations, process 400 includes receiving a second command to bar a network slice associated with a group of subscribers; identifying, based on the second command, the group of subscribers, the network slice to be barred, and one or more active sessions associated with the network slice and the group of subscribers; and providing, to the second network device, another notification indicating to terminate the one or more active sessions associated with the network slice and the group of subscribers and to bar the network slice for the group of subscribers. In some implementations, the other notification causes the second network device to terminate the one or more active sessions associated with the network slice and the group of subscribers and to bar the network slice for the group of subscribers.

In some implementations, process 400 includes receiving, after providing the other notification, a third command to unbar the network slice associated with the group of subscribers, and causing the network slice associated with the group of subscribers to be unbarred based on the third command. In some implementations, the third command enables each of the group of subscribers to initiate an active session with the network slice.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a first network device, a first command to bar a network slice associated with a subscriber;
identifying, by the first network device and based on the first command, the subscriber, the network slice to be barred, and one or more active sessions associated with the network slice and the subscriber; and
providing, by the first network device and to a second network device, a notification indicating to terminate the one or more active sessions associated with the network slice and the subscriber and to bar the network slice for the subscriber.

2. The method of claim 1, wherein the notification causes the second network device to terminate the one or more active sessions associated with the network slice and the subscriber and to bar the network slice for the subscriber.

3. The method of claim 1, further comprising:
receiving, after providing the notification, a second command to unbar the network slice associated with the subscriber; and
causing the network slice associated with the subscriber to be unbarred based on the second command.

4. The method of claim 3, wherein the second command enables the subscriber to initiate an active session with the network slice.

5. The method of claim 1, wherein the first network device is a unified data repository of a core network and the second network device is a unified data management component of the core network.

6. The method of claim 1, further comprising:
storing slice provisioning data associated with the network slice prior to providing the notification to the second network device.

7. The method of claim 1, wherein the first command to bar the network slice is received from a network operator or an automated system.

8. A first network device, comprising:
one or more processors configured to:
receive a first command to bar a network slice associated with a subscriber,
wherein the first command to bar the network slice is received from a network operator or an automated system;
identify, based on the first command, the subscriber, the network slice to be barred, and one or more active sessions associated with the network slice and the subscriber; and
provide, to a second network device, a notification indicating to terminate the one or more active sessions associated with the network slice and the subscriber and to bar the network slice for the subscriber.

9. The first network device of claim 8, wherein the one or more processors are further configured to:
receive a second command to bar a network slice associated with a group of subscribers;
identify, based on the second command, the group of subscribers, the network slice to be barred, and one or more active sessions associated with the network slice and the group of subscribers; and
provide, to the second network device, another notification indicating to terminate the one or more active sessions associated with the network slice and the group of subscribers and to bar the network slice for the group of subscribers.

10. The first network device of claim 9, wherein the other notification causes the second network device to terminate the one or more active sessions associated with the network slice and the group of subscribers and to bar the network slice for the group of subscribers.

11. The first network device of claim 9, wherein the one or more processors are further configured to:
receive, after providing the other notification, a third command to unbar the network slice associated with the group of subscribers; and
cause the network slice associated with the group of subscribers to be unbarred based on the third command.

12. The first network device of claim 11, wherein the third command enables each of the group of subscribers to initiate an active session with the network slice.

13. The first network device of claim 8, wherein the subscriber is associated with a user equipment.

14. The first network device of claim 8, wherein the notification causes the second network device to interact with one or more other network devices to terminate the one or more active sessions associated with the network slice and the subscriber and to bar the network slice for the subscriber.

15. A non-transitory computer-readable medium storing a set of instructions, the set of instructions comprising:
one or more instructions that, when executed by one or more processors of a first network device, cause the first network device to:
receive a first command to bar a network slice associated with a subscriber,
wherein the subscriber is associated with a user equipment;
identify, based on the first command, the subscriber, the network slice to be barred, and one or more active sessions associated with the network slice and the subscriber; and
provide, to a second network device, a notification indicating to terminate the one or more active sessions associated with the network slice and the subscriber and to bar the network slice for the subscriber.

16. The non-transitory computer-readable medium of claim 15, wherein the one or more instructions further cause the first network device to:
receive, after providing the notification, a second command to unbar the network slice associated with the subscriber; and cause the network slice associated with the subscriber to be unbarred based on the second command,
wherein the second command enables the subscriber to initiate an active session with the network slice.

17. The non-transitory computer-readable medium of claim 15, wherein the one or more instructions further cause the first network device to:
store slice provisioning data associated with the network slice prior to providing the notification to the second network device.

18. The non-transitory computer-readable medium of claim 15, wherein the one or more instructions further cause the first network device to:
receive a second command to bar a network slice associated with a group of subscribers;
identify, based on the second command, the group of subscribers, the network slice to be barred, and one or more active sessions associated with the network slice and the group of subscribers; and
provide, to the second network device, another notification indicating to terminate the one or more active sessions associated with the network slice and the group of subscribers and to bar the network slice for the group of subscribers.

19. The non-transitory computer-readable medium of claim 18, wherein the other notification causes the second network device to terminate the one or more active sessions associated with the network slice and the group of subscribers and to bar the network slice for the group of subscribers.

20. The non-transitory computer-readable medium of claim 18, wherein the one or more instructions further cause the first network device to:
receive, after providing the other notification, a third command to unbar the network slice associated with the group of subscribers; and
cause the network slice associated with the group of subscribers to be unbarred based on the third command.
